(19) United States
(12) Patent Application Publication
(10) Pub. No.: US 2006/0198931 A1
(43) Pub. Date: Sep. 7, 2006

(54) Method for obtaining packed food goods, ready for consuming, kept stable at room temperature

(76) Inventor: Jose Barbosa Machado Neto, Sao Paulo (BR)

Correspondence Address: NOTARO AND MICHALOS, 100 DUTCH HILL ROAD, SUITE 110, ORANGEBURG, NY, 10962-2100, US

(21) Appl. No.: 11/244,700

(22) Filed: Oct. 6, 2005

(30) Foreign Application Priority Data
Mar. 4, 2005 (BR) PI 0502898-1
Sep. 28, 2005 (BR) PI 020050104871

(51) Int. Cl. A23B 7/148

(52) U.S. Cl. 426/106

(57) ABSTRACT

The present invention refers to a method for obtaining food goods, particularly lasagna, which is packed of the “ready for consuming” type, which is susceptible of keeping stable preserved at room temperature during the entire chain formed between the industrial manufacture until the consumption/preparation by the end consumer, not requiring, in this manner, refrigeration for its preservation, transport, storage and/or sale exposure, more particularly it refers to a method for preserving “ready for consuming” food product that maintains naturally all its characteristics and quality without requiring a cold chain (cooling and/or freezing) for such; the said manufacturing method may be applied in several pre-cooked foodstuff of the “instant dish” type.

### TECHNICAL FIELD

The present invention relates to a method for providing food goods, particularly lasagna, which is packed, ready for consuming, being preserved stable at room temperature during the entire chain from the industrial manufacture until the consumption/preparation by the end consumer, therefore, without requiring refrigeration for its preservation, transportation, storage and/or sale exposure, more particularly it relates to a method for preserving “ready for consuming” food product that naturally maintains all its characteristics and quality without requiring a cold chain (cooling and/or freezing) for such, using, therefore, the mentioned method and its conditioning in a package especially developed for this purpose; the said manufacturing method may be applied in several pre-cooked foodstuff of the “instant dish” type.

### TECHNICAL GROUNDS

Nowadays, due to the demands of work, study and other tasks, the consumers do not have much time to cook and, because of that, they prefer to purchase “instant dishes”, of easy handling. However, it is also known, principally by manufacturers and producers, that one demand of consumers is that “instant dishes”, after being prepared (warmed in oven or microwave oven) by the consumer, keep the characteristics of a recently prepared meal, that is, flavor close or equivalent to the dishes that the consumer himself elaborates at home, without the so-called “industry flavor.”

Having this done, concerned of the growing market of instant dishes, manufacturers seek to join practicability to nutritional quality in one and the same product, assuring principally its preservation factors, from its preparing until it arrives in the hands of the consumer.

The gondolas of supermarkets and similar commercial establishments show a series of instant dish type products on the basis of chicken meat and beef meat. In function of the characteristics of its preparation, it is estimated that 60% of the frozen and semi-frozen dishes are chicken-based, since studies indicate that due to the fact that the water is the principal component of meat, representing from 60% to 80% of its weight, the ability of chicken meat products in retaining its natural humidity is very important to the industry and to the consumers.

For manufacturers of “instant dishes” type food products, another obligatory condition is the necessity of refrigeration and/or freezing of the products during the entire chain, from manufacture, passing through transportation, storage until the exposure for sale, to assure the maintenance of their original characteristics and quality, delaying the microbiological, enzymatic and physical-chemical degradation process. Without the abovementioned cold chain the prepared product after a determined space of time, would turn out unfit for consumption.

In the case of commercialized products like “instant dishes”, which come already seasoned and cooked/roasted/fried, this need becomes even more present.

Such need is given due to the fact that seasoned and cooked/roasted/fried food product becomes more sensitive to degeneration due to thermal issues and it is also a fact that the temperature of the planet earth has risen significantly in the last years, in accordance with scientific studies denominated as “oven effect”, which comes to affect directly all food products exposed to the end consumer, principally at the moment of their transportation.

Through investigations, it is known that one of the instant dishes of greatest popular preference is “lasagna”, knowingly made with pasta, chicken or beef meat and/or legumes, accompanied by sauces in general, as well as cheeses.

So the best way to explain the purpose of this invention is to demonstrated, as follows, the traditional way of manufacturing, transporting and commercializing the instant dish type frozen or semi-frozen “lasagna”, such as commonly found in its sale in several specialized commercial establishments. The traditional exemplificative situation is under mentioned:
a) After preparing/processing, the making of lasagna and its ingredients and side dishes, a rapid freezing of its portions, immediately after its preparation, is necessary as a condition for the maintenance of its characteristics and, soon afterwards, comes the need of conditioning this product in storage chambers at low temperatures until the moment of its transfer to Distribution Centers and/or Warehouses;
b) To carry out the transportation of the prepared and frozen lasagna, the use of special transportation, that is, vehicles with refrigeration compartments is necessary, aiming at the maintenance of the ideal temperature during the transportation, assuring in this manner the maintenance of the cold chain of the product until its destination;
c) After its arrival at the Distribution Center and/or Warehouse, the product must still be kept in cold chamber seeking, still, the maintenance of the necessary cold chain until the moment of transfer of this product with destination to the point of sale, which must be done in the same manner in refrigeration trucks;
d) After its arrival at the point of sale, the product must be immediately conditioned in refrigeration chambers and/or carried directly to the also refrigerated exposition counters for sale until the consumer decides through its purchase, during the entire time that the product is in exposition; the refrigeration displays must remain connected, assuring the product the ideal temperature conditions.

It is of common knowledge that during the stocking period of the product in the refrigeration chamber of the transportation vehicle, as well as at the moment of withdrawal the product from this vehicle and stocking it at the Distribution Center and/or Warehouses, that the professionals involved in this process are exposed to low climatic temperatures, affecting directly their health, besides involving the need of special mechanisms like coolers and refrigerators that end up endearing the production chain.

Only as an example, some manufacturing methods of “lasagna” are known, such as in the document PI 9801777-2 entitled: Food Product with Layers of Pasta—where the method for preparing and providing lasagna-type food product, includes layers of pasta arranged on a pan, wherein a cooking liquid is added, which will be heated. The food segments are frozen individually and are in the form of rhomboids. The said food segments and cooking liquids are heated at least at 50° C. with separations between them and they include sheets of whitened pastas, at least with 3 layers, with a length or width of 2 to 12 cm, whose weight of each unit of the segment of lasagna is 20 to 80 grams, preferably 40 to 60 grams and 2 to 3 cm of thickness. The lasagna has an upper browned surface. The food product segments are encapsulated in a comestible coating preferably sauce.

On the other hand, once the consumer buys it, he remains responsible for the maintenance of the temperature conditions to assure the quality of the product, since during the entire operation that involves the production, passing through transportation, storage and commercialization of the product, it is understood that the product would be under the responsibility of trained professionals that have at their disposal necessary machines and equipments aiming to assure the maintenance of the characteristics and quality of the product.

From the moment when the consumer purchases the product, it is taken into account that the said product suffers temperature changes until it arrives in an environment that propitiates a minimum of refrigeration, also taking into account, even and mainly the fact that many times, the consumer may not be technically trained and he does not have all the machines, equipments and technology necessary to keep the product under minimum temperature conditions that can assure the maintenance of the characteristics and quality of the product.

By choosing the purchase of the product, the client normally withdraws the product from the refrigerated exhibitor where it is found conditioned and transfers it to his shopping cart, where it will stay for some time until the consumer can finish his shopping, still inside the commercial establishment. After finishing his shopping the client must pass all his products through “check-out”, to perform the payment of the purchases. Right after the payment, all products are normally conditioned in bags and taken to the transportation vehicle (the client's or other equivalent), which is supposed, will be driven directly to his residence or establishment, where the product should be transferred into a freezer-type refrigeration equipment or similar, aiming to keep the product frozen.

Observe, therefore, that hypothetically since the moment when the client chooses the purchase of the product and withdraws the product from the refrigeration exhibitor until the moment the product arrives in his residence and he conditions the product in his freezer, it can end up taking some hours, which could certainly endanger the quality of the product, without taking into consideration that the product must be kept inside the freezer for its preservation and defrosted before consumption, and also considering that this product during the entire distribution chain has been kept in ideal refrigeration conditions, also that its validity was not changed, anyway it may happens that when it is opened for preparation by the consumer it can be presented unfit for consumption.

The packing materials especially destined to better preserve the product for a longer time, are already known to the consuming public, especially to manufacturers of “instant dishes”. Among these packing materials, it is worth stressing the document BR/MU 7801384-4 “Packing material for the conditioning of food products”, which includes a carton box incorporating internally and additionally, an impermeable film material and presenting two lateral walls, two extreme walls and a bottom wall, interconnected among themselves through defining crease lines at the lower vertical and horizontal edges of the box. However, this packaging does not have any special process of maintenance of quality or heat of foods.

Another known document, BR/MU 8102688-9 refers to a “Disposal in Packaging for Transport of Foods”, especially developed to condition food, closing it hermetically, composed of a small internal tray, made of plastics and has internal grooves, whose purpose is to serve as mechanism to support high temperatures, keeping the food always warm during transportation until its placement for consumption, supporting even vegetable and animal fat, with property of preserving the properties of the food and its hygienic conditions.

Another document found in the state of the art refers to BR/MU 8200341-6 for “Constructive Disposal Introduced in Packaging”, which is formed from a single sheet, produced in cardboard or another adequate material, whose sheet is cut, creased and afterwards folded so as to define the three-dimensional format of the present packaging, defined by two large walls. This packaging, however, does not have any special process of maintenance of quality or heat/cooling of foods.

The document BR/PI 0102284-9 refers to a “Packaging for Conditioning of solid comestible products”, which includes a main base wall, extending at least a lateral wall, defining the cavity, wherein the said packaging is characterized by the fact that it includes at least a pass opening, located on the lateral wall. The pass opening is a rabbet at the height of the lateral wall, whose rabbet is located adjacent to the free extremity of the lateral wall, containing two rabbets and including between the rabbets a limiting element to prevent the comestible product movement and this limiting element is a dividing wall. The first and main base wall presents a rectangular format, extending to four lateral walls, arranged in twos in parallel.

As it can be seen, the existing developed packing materials do not have the expected principal property, which does exist in the present privilege, and which is that of maintaining, naturally, all the characteristics of the pre-cooked packed product ready for consumption, dispensing the cold chain (cooling and/or freezing) for preservation, transportation, storage and/or sale exposure.

### BRIEF DESCRIPTION OF THE INVENTION

In order to eliminate the present inconveniences in the above related state of art, the petitioner, acting in the food area, developed the present method for providing food goods, particularly “lasagna”, which is packed in a especially developed package ready for consuming, susceptible of keeping stable preserved at room temperature, during the entire chain formed from the industrial manufacture until the consumption/preparation by the end consumer, this method for providing “instant dish” that applies to seasoned foods, cooked/roasted/fried type preparation, ready for consumption, enough just to heat it in the oven or microwave oven, such as instant dishes that are commonly found available for the consumer, however with a great differential, that is, the “instant dish” product whose method of obtaining is well innovated, dispenses refrigeration in all the stages of the process, from its production, transportation, storage and/or sale exposure, until domestic storage of the product by the consumer.

The advantages are innumerous that originate from this method for providing food product and its packaging, wherein one of them is the fact that the product does not require any special care with the cold chain, and it can be stored, at room temperature, right immediately after the production process, consequently it does not require transportation in special vehicles containing refrigerators until the Distribution Center and/or point of sales.

Another advantage is in the fact that, once inside the commercial establishment where it is going to be commercialized, the product may be exposed in common exhibitors, that is, there is no need of exposure of the product in refrigerated exhibitors, so these machines can be reduced for the purpose of saving expenses with electrical energy, or they can be supplied with other products that require refrigeration.

Another great advantage resides in the act of purchase by the consumer, since he may, upon acquiring the product, carries it for hours or days inside the vehicle, without the need of special care with the temperature, since the product besides not requiring refrigeration, it supports radical temperature changes, such that the consumer can even, for example, maintain the product stored in his farm, country house, beach house, for months without requiring to have a cooler or any other refrigeration equipment, being sufficient just to keep the packaging intact, that is, hermetically sealed, wherein the stocking area must be clean and preserving the normal standards for conditioning any product that dispenses refrigeration, in order that the quality as well as the original characteristics of the product will be kept, so the product is ready for consumption at any time, being sufficient just to heat it.

The products elaborated from the present method, have commercial presentation similar to market products, that is, they are presented conditioned in plastic trays, sealed on the upper part with flexible film.

However, the packaging used, the tray as well as the sealing film of the product, for example “lasagna” were especially designed, along with the method of its obtaining, so as to allow the product not to require refrigeration, as above mentioned guaranteeing the maintenance of all its original characteristics, assuring the quality, the color, the flavor and the texture as long as it is kept inside its original hermetically sealed packaging.

Such facts make most consumers, distributors and traders widely benefited, in several ways, with the well-innovated method for providing instant dishes.

### BRIEF DESCRIPTION OF THE DRAWINGS

To complement the present description so as to obtain a better understanding of the characteristics of the present invention and in accordance with its preferential practical performance, there is attached to this description, a set of designs, in an exemplified manner, although not limiting the description, the following is represented.

FIG. 1 shows a representative flowchart of the present method;

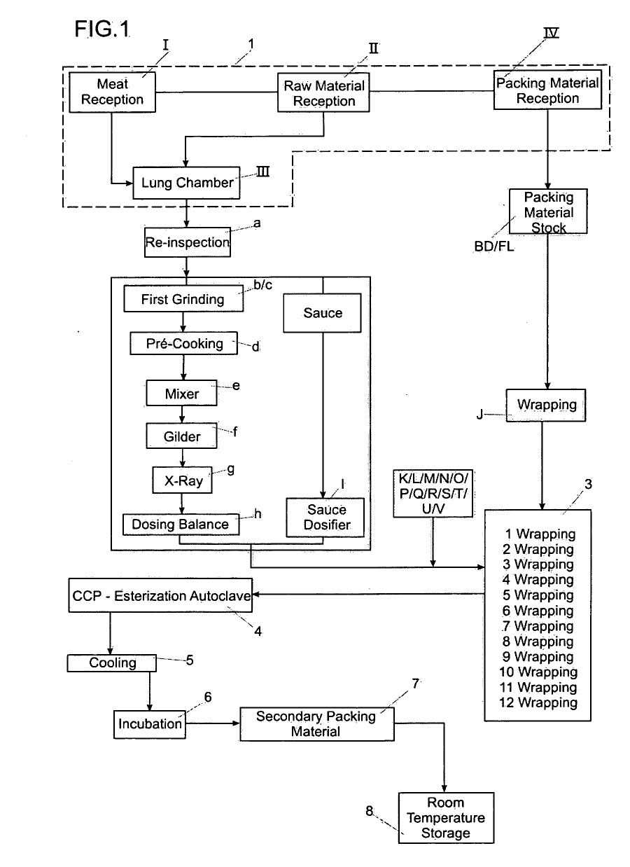

FIG. 2 shows a tray-type packaging and the respective sealing film;

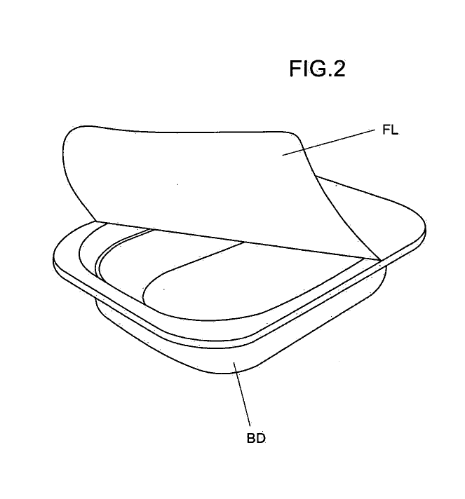

FIGS. 3, 4, 5 and 6 are perspective views of a “lasagna” product prepared and packed according to the purposes of the present invention.

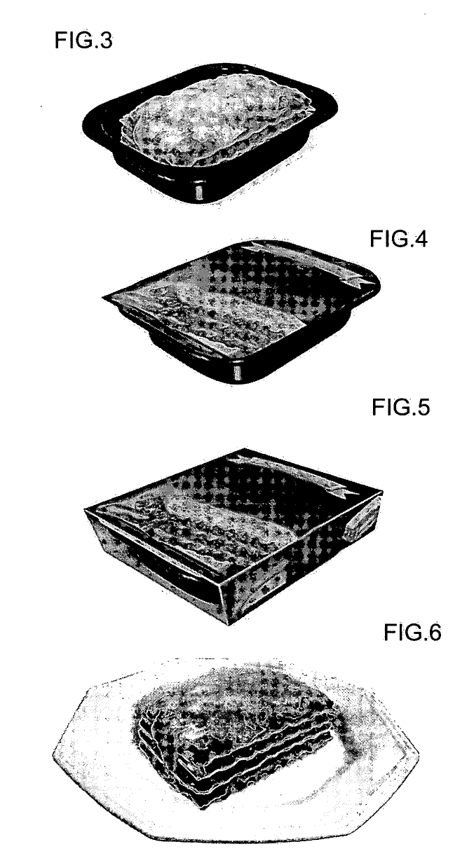

### DETAILED DESCRIPTION OF THE INVENTION

With reference to illustrative drawings, the present invention relates to the “METHOD FOR OBTAINING PACKED FOOD GOODS, READY FOR CONSUMING, KEPT STABLE AT ROOM TEMPERATURE”, method for providing food goods, particularly “lasagna”, which is packed, ready for consuming, such that it is susceptible of keeping stable preserved at room temperature during the entire chain formed between the industrial manufacture until the consumption/preparation by the end consumer, not requiring, in this manner, refrigeration for its preservation, transportation, storage and/or sale exposure.

The present method for obtaining the product type “instant lasagna dish” consists in the following stages:
1) Raw Material Reception: All ingredients and packing materials will be received in accordance with the technical specification of each one;
2) Preparation process of the ingredients and raw materials for the making of the product; processing of the ingredients and mounting of portions of lasagna;
3) Packing: After making the product portion, in the case of lasagna with Bolognese sauce, inside the corresponding plastic tray (BD), it is hermetically sealed, with special high-barrier films (FL), preventing the entry of oxygen into the packaging after it has been sealed;
4) Sterilization: After being hermetically sealed the trays (BD) are placed in special carts, dimensioned to be conditioned inside the autoclaves and forwarded to the sterilization process;
5) Cooling: The trays must be cooled quickly until they reach a minimum temperature of 35° C. in chlorinated water (5 ppm), so that they retain sufficient heat to freeze-dry them.
6) Incubation: After the cooling process one in every thousand (1,000) sterilized units is collected to be incubated in a room where the temperature must remain between 34° C. and 38° C. during the minimum period of 10 days, for the purpose of stimulating the growth of microorganisms that may, for some failure in the sterilization process, have resisted the thermal treatment, so that in this manner can, thus, assure the sterility of the product while it remains into its original hermetically sealed packaging; and
7) Secondary packing: After the proven efficiency in the sterilization process, the product is released by Quality Control to be transferred to the secondary packing sector, where the tray will be conditioned in a case containing all information with respect to the product in accordance with what the current legislation determines and distributed to the points of sale;
8) Forwarding to a room where this secondary packing process happens it is kept at room temperature since the product does not require refrigeration for the maintenance of its original characteristics.

The plastic tray (BD) was especially developed to contain the pre-cooked product through the mentioned method and it is made in sheet whose structure presents the following layers: PP/EVOH/PP.

The internal layer that stays in contact with the ready food is PP and must be forwarded to sterilization before receiving the ready product; the tray presents a barrier characteristic against UV, in accordance with the IFC (International Food Company) rules and it is resistant to microwaves.

After conditioning the “ready for consuming” product inside the tray, it receives, on the surface of the lateral flaps, a plastic film (FL) as a cover, which, after the vacuum process, is thermo-sealed in the tray; once sealed the packaging is conditioned inside of a cardboard carton, whose external faces receive the entire range of information for the consumer.

This tray was developed to resist great temperature variation, which can support freezing at the lowest temperatures (−40° C.) until the sterilization process at elevated temperatures (+200° C.).

The raw material reception stage has the following technical characteristics:

I) Reception of Meat “in Natura”: in sanitary area, with temperature control counting on all necessary infrastructure for the execution of a complete checking and verification of the product;

II) Reception of Ingredients: pre-cooked pasta, Tomato sauce, White Sauce, Cheese and Ham, Legumes, Spices, to be performed in aseptic environment, refrigerated counting on all infrastructure for the execution of the reception and of the checking of all raw materials in accordance with their specifications;

III) Lung chamber: where the products shall be stored in accordance with their specifications assuring in this manner the maintenance of the stability and characteristic of each one; and

IV) Reception of the packing materials (trays and sealing films).

The preparation and making process of the product, preferably lasagna with Bolognese sauce, follows the following technical characteristics:

a) Re-inspection of the raw materials and ingredients:

b) Grinding of the Meat: through the transfer of the meats, received, inspected and stored in refrigeration chambers for the industrial grinding machines;

c) Water treatment;

d) Pre-cooking of the ground meat: where the meats are transferred through special belts of the industrial grinders up to the cookers;

e) Mixer: where the meat, after being cooked in the cookers, is transferred through endless threads made in 304 stainless steel with sanitary finishing especially elaborated for this purpose where they will be mixed with the seasoning;

f) Circular gilder: where the ground meats, after having been cooked and seasoned are transferred through endless threads, made in 304 stainless steel with sanitary finishing especially elaborated for this purpose, where the meat will be gilded through a system of infrared lights also especially constructed for this purpose;

g) Passage through the X-Ray system: for detection of possible foreign objects in the product; metal, bone, plastic, among others;

h) Dosing balance of the cooked, seasoned and gilded ground meat and seasoned tomato sauce;

i) Sauce Dosifiers: conditioning of the ready Bolognese sauce in automatic dosing machines;

j) Vacuum packing machines inside special plastic trays for sterilization of food products;

k) First dosing of Bolognese sauce inside the tray through automatic dosing nozzles;

l) Placement of the first layer of lasagna pasta inside the tray;

m) Second dosing of Bolognese sauce over the lasagna pasta through automatic dosing nozzles inside the tray;

n) Placement of the second layer of lasagna pasta inside the tray;

o) Third dosing of Bolognese sauce over the lasagna pasta through automatic dosing nozzles;

p) Placement of a layer of slices of ham inside the tray;

q) Fourth dosing of Bolognese sauce over the slices of ham through automatic dosing nozzles inside the tray;

r) Placement of the third layer of lasagna pasta inside the tray, wherein legumes can be added;

s) Placement of a layer of Cheese over the lasagna pasta inside the tray, wherein legumes can be added;

t) First dosing of white sauce over the layer of cheese through automatic dosing nozzles;

u) Placement of the first layer of cheese spread over the layer of cheese through automatic dosing nozzles inside the tray;

v) Placement of the last layer of white sauce over the layer of cheese spread through dosing nozzles inside the tray.

Thus proceeding, the lasagna prepared inside the plastic tray, according to this method, presents the following configuration in layers from bottom up: 1) Bolognese Sauce; 2) Pasta; 3) Bolognese Sauce; 4) Pasta; 5) Bolognese Sauce; 6) Ham; 7) Bolognese Sauce; 8) Pasta; 9) Cheese, 10) White sauce; 11) Cheese spread and 12) White sauce.

The sterilization stage includes where, after hermetically sealed, the trays are placed and forwarded to the autoclaves for the sterilization process. This process is performed through special equipments developed, designed and conceived exclusively for the purpose of sterilizing, through thermal treatment, food products conditioned in hermetically sealed plastic trays, so as not to harm and/or cause fissures in this type of packaging.

Along with the temperature indicating instrument is mounted another instrument, wherein this is a temperature/time registering device.

The products, already inside their hermetically sealed packagings, without the possibility of re-contamination, pass through a thermal sterilization process, inside the autoclave for a time that varies from 12 to 20 minutes, wherein this time can be reduced or increased, depending on the quantity and mass of the ingredients used until it is verified that the interior of the product reaches a temperature of 121.5° C. eliminating all live microorganisms, turning in this manner the product sterile, wherein this temperature can also be reduced or increased;

In Autoclave yet several equipments are installed alike; Mercury thermometer (calibrated every Six months against a standard instrument traced by RBC).—Manometer (calibrated daily and every Six months against a standard instrument traced by RBC).—Time and Temperature Registering Graph Chart (calibrated daily and every Six months against a standard instrument traced by RBC).

Having this done, the packaging used, the tray as well as the dealing film of the product, for example “lasagna” were especially designed, along with the obtaining method, so as to permit the product not to require refrigeration, as mentioned above, assuring the maintenance of all its original characteristics, ensuring the quality, the color, the taste and the texture as long as kept inside its original hermetically sealed packaging.

Despite having detailed the invention, it is important to understand that it does not limit its application to the details and stages described herein. The invention is able for other modalities and for being practiced or executed in a variety of ways. It must be understood that the terminology herein applied is for the purpose of description and not of limitation.

1. “METHOD FOR OBTAINING PACKED FOOD GOODS, READY FOR CONSUMING, KEPT STABLE AT ROOM TEMPERATURE”, WHEREIN the method for providing food goods, particularly “lasagna”, is packed, ready for consuming, keeping stable preservation at room temperature during the entire chain formed between the industrial manufacture until the consumption/preparation by the end consumer; the method for obtaining “pre-cooked lasagna” product consists in the following stages:
1) Raw Material Reception: All ingredients and packaging materials will be received in accordance with the technical specification of each one;
2) Preparation process of the ingredients and raw materials for preparing the product; processing of ingredients and mounting of portions of lasagna;
3) Packing: After the making of the product inside the corresponding plastic tray (BD), it is hermetically sealed with special high-barrier films (FL), preventing the entry of oxygen into the packaging after it has been sealed;
4) Sterilization: After hermetically sealed the trays are placed in special carts, dimensioned to be conditioned inside the autoclaves and forwarded to the sterilization process;
5) Cooling: The trays must be cooled quickly until they reach a minimum temperature of 35° C. in chlorinated water (5 ppm, so that they retain sufficient heat to dry them.
6. Incubation: After the cooling process, one in every thousand (1,000) sterilized units is collected to be incubated in a room where the temperature must remain between 34° C. and 38° C. during a minimum period of 10 days, with the purpose of stimulating the growth of microorganisms that may, for some failure in the sterilization process, have resisted the thermal treatment, thus in this manner the sterility of the product can be assured while it remains inside its original hermetically sealed packaging; and
7) Secondary packaging: After the proven efficiency in the sterilization process, the product is released by Quality Control to be transferred to the secondary packing sector, where the tray will be conditioned in a case containing all the information with respect to the product and distributed to points of sale;
8) Forwarding to a room where this secondary packing process is kept at room temperature since the product does not require refrigeration for the maintenance of its original characteristics.

2. “METHOD FOR OBTAINING PACKED FOOD GOODS, READY FOR CONSUMING, KEPT STABLE AT ROOM TEMPERATURE”, in accordance with claim 1, WHEREIN the raw material reception stage and following present the respective technical features:
I) Reception of Meat “in Natura”: in sanitary area, with temperature control counting on all necessary infrastructure for the execution of a complete checking and verification of the product;
II) Reception of Ingredients: Pre-cooked pasta, Tomato sauce, White sauce, Cheese, Ham and Legumes, to be performed in aseptic environment, refrigerated, counting on all infrastructure for the execution of the reception and checking of all raw materials in accordance with their specifications;
III) Lung chamber: where the products shall be stored in accordance with their specifications assuring in this manner the maintenance of the stability and characteristic of each one; and
IV) Reception of the packing materials (trays and sealing films).

3. “METHOD FOR OBTAINING PACKED FOOD GOODS, READY FOR CONSUMING, KEPT STABLE AT ROOM TEMPERATURE”, in accordance with claim 1, and in a preferential arrangement of lasagna with meat, WHEREIN the preparation and making process of the product observe the following technical features:
a) Re-inspection of the raw materials and ingredients:
b) Grinding of the Meat: through the transfer of the meats, received, inspected and stored in refrigeration chambers to the industrial grinding machines;
c) Water treatment;
d) Pre-cooking of the ground meat: where the meats are transferred through special belts from the industrial grinders up to the cookers;
e) Mixer: where the meat, after being cooked in the cookers, is transferred through endless threads made in 304 stainless steel with sanitary finishing especially elaborated for this purpose where they will be mixed to the seasoning;
f) Circular gilder: where the ground meats, after having been cooked and seasoned are transferred through endless threads, made in 304 stainless steel with sanitary finishing, especially elaborated for this purpose, where the meat will be gilded through a system of infrared lights also especially constructed for this purpose;
g) Passage through X-Ray system: for detection of possible foreign objects in the product; metal, bone, plastic, among others;
h) Dosing balance of the cooked, seasoned and gilded ground meat and seasoned tomato sauce;
i) Sauce Dosifiers: conditioning of the ready Bolognese sauce in automatic dosing machines;
j) Vacuum packaging machines inside the special plastic trays for sterilization of food products;
k) First dosing of Bolognese sauce inside the tray through automatic dosing nozzles;
l) Placement of the first layer of lasagna pasta inside the tray;
m) Second dosing of Bolognese sauce over the lasagna pasta through automatic dosing nozzles inside the tray;
n) Placement of the second layer of lasagna pasta inside the tray;
o) Third dosing of Bolognese sauce over the lasagna pasta through automatic dosing nozzles;
p) Placement of a layer of slices of ham inside the tray;
q) Fourth dosing of Bolognese sauce over the slices of ham through automatic dosing nozzles inside the tray;
r) Placement of the third layer of lasagna pasta inside the tray, wherein legumes can be added;
s) Placement of a layer of Cheese over the lasagna pasta inside the tray, wherein legumes can be added;
t) First dosing of white sauce over the layer of cheese through automatic dosing nozzles;
u) Placement of the first layer of cheese spread over the layer of cheese through automatic dosing nozzles inside the tray;
v) Placement of the last layer of white sauce over the layer of cheese spread through dosing nozzles inside the tray.

4. METHOD FOR OBTAINING PACKED FOOD GOODS, READY FOR CONSUMING, KEPT STABLE AT ROOM TEMPERATURE”, in accordance with claim 3, WHEREIN the sterilization stage includes a temperature indicating instrument mounted along with a temperature/time registering device.

5. “METHOD FOR OBTAINING PACKED FOOD GOODS, READY FOR CONSUMING, KEPT STABLE AT ROOM TEMPERATURE”, in accordance with claim 1, WHEREIN in the sterilization stage the products, already inside their hermetically sealed packagings, pass through a thermal sterilization process, inside the autoclave for a time that varies from 12 to 20 minutes, wherein this time can be reduced or increased, depending on the quantity and mass of the ingredients used until it is proven that the interior of the product reaches a temperature of 121.5° C. eliminating all live microorganisms, turning in this manner the product sterile, wherein this temperature can also be increased or reduced.

6. “METHOD FOR OBTAINING PACKED FOOD GOODS, READY FOR CONSUMING, KEPT STABLE AT ROOM TEMPERATURE”, in accordance with claim 1, and in a preferential construction according to the present method, WHEREIN the lasagna prepared inside the plastic tray presents the following configuration in layers from bottom up: 1) Bolognese sauce; 2) Pasta; 3) Bolognese Sauce; 4) Pasta; 5) Bolognese Sauce; 6) Ham; 7) Bolognese Sauce; 8) Pasta with or without legumes; 9) Cheese with or without legumes, 10) White sauce; 11) Cheese spread and 12) White sauce.

7. “METHOD FOR OBTAINING PACKED FOOD GOODS, READY FOR CONSUMING, KEPT STABLE AT ROOM TEMPERATURE”, in accordance with claim 1, WHEREIN the plastic tray (BD) is made in sheet whose structure presents the composition of PP/EVOH/PP (Polypropylene/EVOH/Polypropylene), adapted lower base, lateral walls and upper flaps; after the vacuum process the tray receive plastic film (FL), wherein it is thermo-sealed in its upper flaps; once sealed the package is conditioned in the interior of a cardboard carton.

8. “METHOD FOR OBTAINING PACKED FOOD GOODS, READY FOR CONSUMING, KEPT STABLE AT ROOM TEMPERATURE”, in accordance with claim 1, WHEREIN the tray resists the great temperature variation, wherein it can support from freezing at the lowest temperatures (−40° C.) up to the sterilization process at elevated temperatures (+200° C.), keeping the food goods with its normal characteristics and quality for long period of time.

9. “METHOD FOR PROVIDING PACKAGED FOOD GOODS, READY FOR CONSUMING, KEPT STABLY PRESERVED AT ROOM TEMPERATURE”, in accordance with claim 1, WHEREIN the product obtained dispenses refrigeration for its preservation, as well as transportation, storage and/or sale exposure and storage on the part of the consumer.
